(19) United States
(12) Patent Application Publication
(10) Pub. No.: US 2009/0321327 A1
(43) Pub. Date: Dec. 31, 2009

(54) Wet Garbage Recycling

(76) Inventor: Michael Anguelo, Miami Springs, FL (US)

Correspondence Address: Michaelanguelo-International Co., 733 Curtis Pkwy, Apt 1B, Miami Springs, FL, 33166, US

(21) Appl. No.: 12/164,087

(22) Filed: Jun. 29, 2008

(51) Int. Cl. B03B 9/00; B03C 1/30; B03B 5/28

(52) U.S. Cl. 209/40

(57) ABSTRACT

The Water Garbage Recycler is a system to recycle waste by using water as a medium to classify and extract waste material. Water causes lightweight materials to float to the surface where they are collected for processing. These materials are shredded and compacted in bales to be recycled. Likewise, heavier objects such as metals sink to the bottom and are collected and transported to be processed appropriately. The source of water is a sewer plant where it can be redeposited for recycling. This method of processing waste is ecologically friendly because ninety nine percent of the waste material can be recycled efficiently.

### BACKGROUND OF THE INVENTION

The present invention relates to garbage recycling, and more particularly, to a mechanism for recycling waste using water.

### SUMMARY OF THE INVENTION

The Wet Garbage Recycler is a new concept of recycling waste more efficiently. It consists of a main water tank and conveyor system to classify and extract various types of garbage.

A water tank is used as a medium for separating floating objects from heavy ones. Water jets produce a swirl in the tank to that floating garbage will accumulate in the upper middle of the tank. There are conveyor belts to extract floating objects and a screw system to extract heavy objects from the bottom of the tank.

Floating waste passes through a shredding system to chop the garbage in smaller pieces. The garbage will then pass through a series of rollers to squeeze out liquids and compress the material. The material will then be extracted to a compactor and made as small in volume as possible into bales to be carried away for further processing.

Heavy waste is extracted from the water tank using a screw conveyor. It then passes through a conveyor system where a series of magnets that separate ferrous and non-ferrous metals. Non-ferrous metals and other heavy materials go through a grinding process to separate silica based materials from other non-ferrous metals and other materials. The remains are then carried away for further processing.

### BRIEF DESCRIPTION OF THE DRAWINGS

FIG. 1 Illustration of complete Wet Garbage Recycling system showing flow of materials.

FIG. 2 Illustration of water tank and water flow.

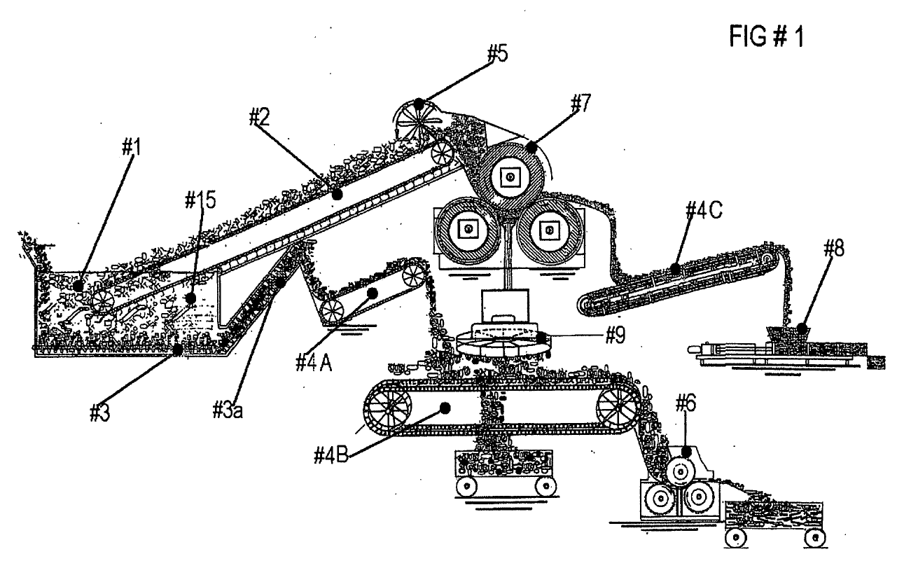

1. FIG. 1
1. Water tank where garbage is dumped and floating objects separate from heavy ones.
2. Conveyor that transports floating materials to be shredded to smaller pieces.
3. A screw conveyor to transport heavy materials to a magnetic system for collecting ferrous materials.
4. 4A, 4B, 4C are conveyors for transporting materials.
5. Shredding system to chop waste material into smaller pieces.
6. A series of rollers that grind non-ferrous metals and other materials.
7. A series of rollers to extract liquids and compress materials to be compacted.
8. Compactor for compressing waste into bales for further processing.
9. Magnetic system to extract ferrous metals from heavy materials.

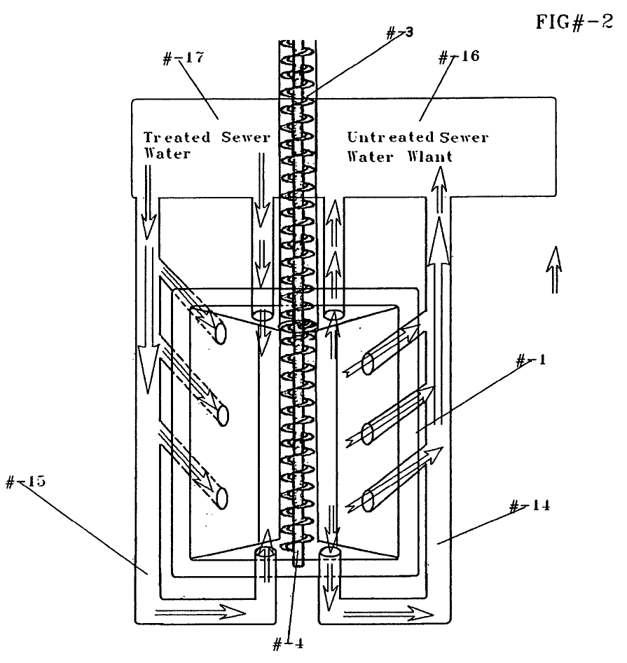

2. FIG. 2
1. Water tank where garbage is dumped and floating objects separate from heavy ones.
3. Conveyor screw that transports heavy objects.
4. Conveyor screw that transports heavy objects.
14. Pipeline where water returns to untreated sewer water.
15. Pipeline where water comes from treated sewer water.
16. Sewer plant untreated water reservoir.
17. Sewer plant treated water reservoir.
